(19) United States
(12) Patent Application Publication
(10) Pub. No.: US 2006/0149519 A1
(43) Pub. Date: Jul. 6, 2006

(54) Hybrid vehicle parameters data collection and analysis for failure prediction and pre-emptive maintenance

(76) Inventor: Jesse P. Keller, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/273,387

(22) Filed: Nov. 14, 2005

Related U.S. Application Data
(60) Provisional application No. 60/628,029, filed on Nov. 15, 2004.

(51) Int. Cl. G06G 7/48

(52) U.S. Cl. 703/8

(57) ABSTRACT

A method of collecting and analyzing large amounts of continuous real time vehicle measurement data from more than 50 monitored parameters includes providing a system for collecting and analyzing large amounts of continuous real time vehicle measurement data from more than 50 monitored parameters; receiving continuous real time vehicle measurement data from more than 50 monitored parameters and filing the data into parameter data logs; analyzing data trends and associations in the vehicle measurement data; identifying subsystem and component failures from the analyzed data trends and associations; classifying and reporting pending failures and failures based on the identified subsystem and component failures; and updating and training the system to recognize new failures and pending failures.

### CROSS-REFERENCE TO RELATED APPLICATIONS

This application claims the benefit of U.S. Provisional Application 60/628,029 filed Nov. 15, 2004 under 35 U.S.C. 119(e). The drawings and disclosure of U.S. Application 60/628,029 are hereby incorporated by reference as though set forth in full.

### FIELD OF THE INVENTION

The present invention relates to the field of expert systems, and more particularly to an expert system and method for diagnosing potential failures and pre-emptive maintenance requirements in a hybrid vehicle or electric vehicle.

### SUMMARY OF THE INVENTION

An aspect of the invention involves a method to collect large amounts of continuous real-time measurement data for a large number of measured parameters on-board a heavy-duty hybrid-electric or electric vehicle, and use statistical analysis and automatic learning techniques on time histories to discover and learn about single and multiple parameter interactions that can be used for status and failure prediction. For example, more than 50 parameters may be measured and collected continuously during vehicle operation. Bayesian auto learning analysis processing is applied to the data collected to discover cross correlations that can be used to identify performance degradation trends and impending component failure. Any identified malady is assigned an error code that is communicated to maintenance personnel. Furthermore, the discovered multiple parameter relationship is communicated to all the other maintenance personnel and/or computers for that vehicle class fleet.

Another aspect of the invention involves a method of collecting and analyzing large amounts of continuous real time vehicle measurement data from more than 50 monitored parameters includes providing a system for collecting and analyzing large amounts of continuous real time vehicle measurement data from more than 50 monitored parameters; receiving continuous real time vehicle measurement data from more than 50 monitored parameters and filing the data into parameter data logs; analyzing data trends and associations in the vehicle measurement data; identifying subsystem and component failures from the analyzed data trends and associations; classifying and reporting pending failures and failures based on the identified subsystem and component failures; and updating and training the system to recognize new failures and pending failures.

A further aspect of the invention involves a computer-implemented system for collecting and analyzing large amounts of continuous real time vehicle measurement data from more than 50 monitored parameters. The system includes a module to receive continuous real time vehicle measurement data from more than 50 monitored parameters and file the data into parameter data logs; a module to analyze data trends and associations in the vehicle measurement data; a module to identify subsystem and component failures from the analyzed data trends and associations; a module to classify and report pending failures and failures based on the identified subsystem and component failures; and a module to update and train the system to recognize new failures and pending failures. One example is to learn the percentage of time that the air compressor is running during normal operation. If the air compressor is running more than a “threshold” percentage, there is probably a “failed” air system component.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 is a simplified schematic of an embodiment of a heavy-duty hybrid-electric or electric vehicle with an embodiment of a system for diagnosing a potential failure in the hybrid vehicle or electric vehicle.

FIG. 2 is a block diagram of an embodiment of the system for diagnosing a potential failure in a hybrid vehicle or electric vehicle.

FIG. 3 is a flow chart of an exemplary method for diagnosing a potential failure in a hybrid vehicle or electric vehicle.

FIG. 4 is a flow chart of an exemplary method of automatic learning for retraining the system with new failure data.

FIG. 5 is a block diagram depicting an embodiment of a computer that may be used to implement the system and method of the present invention.

### DETAILED DESCRIPTION OF A PREFERRED EMBODIMENT

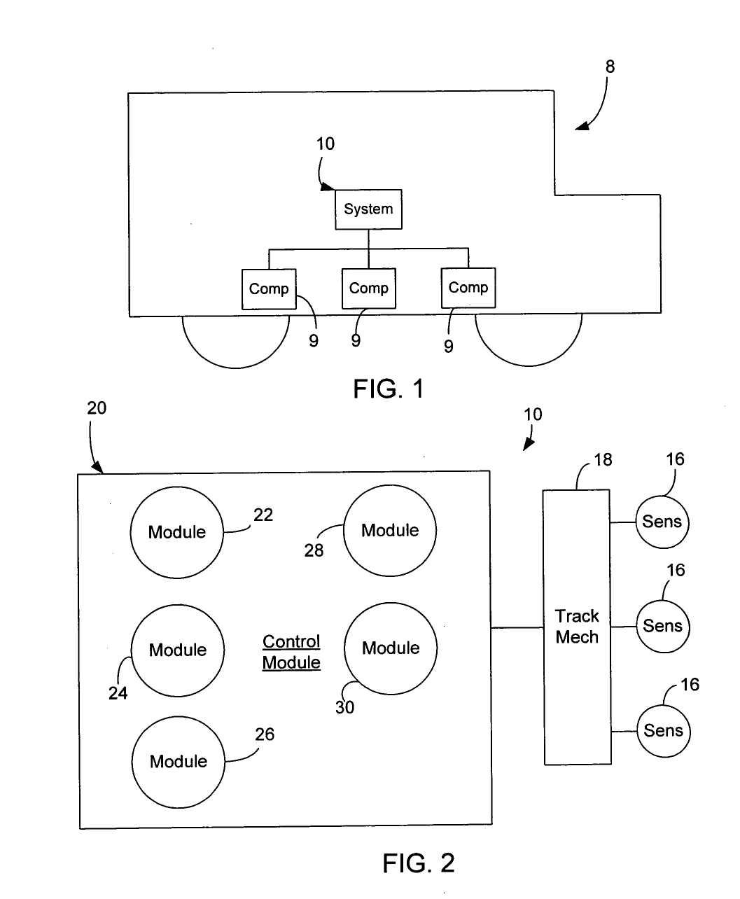

With reference to FIGS. 1-5, a system and method of failure prediction of one or more components or sub-systems of a heavy-duty hybrid-electric or electric vehicle will be described. As used herein, a heavy-duty hybrid-electric or electric vehicle is a hybrid-electric or electric vehicle having a gross vehicle weight of at least 10,000 lbs. Although the system and method will be described in conjunction with failure prediction in a heavy-duty hybrid vehicle or electric vehicle or electric vehicle, the system and method may be applied to other types of vehicles.

With reference to FIG. 1, a heavy-duty hybrid-electric or electric vehicle 8 includes an embodiment of system 10 for failure prediction of one or more components or sub-systems 9 of the heavy-duty hybrid-electric or electric vehicle 8.

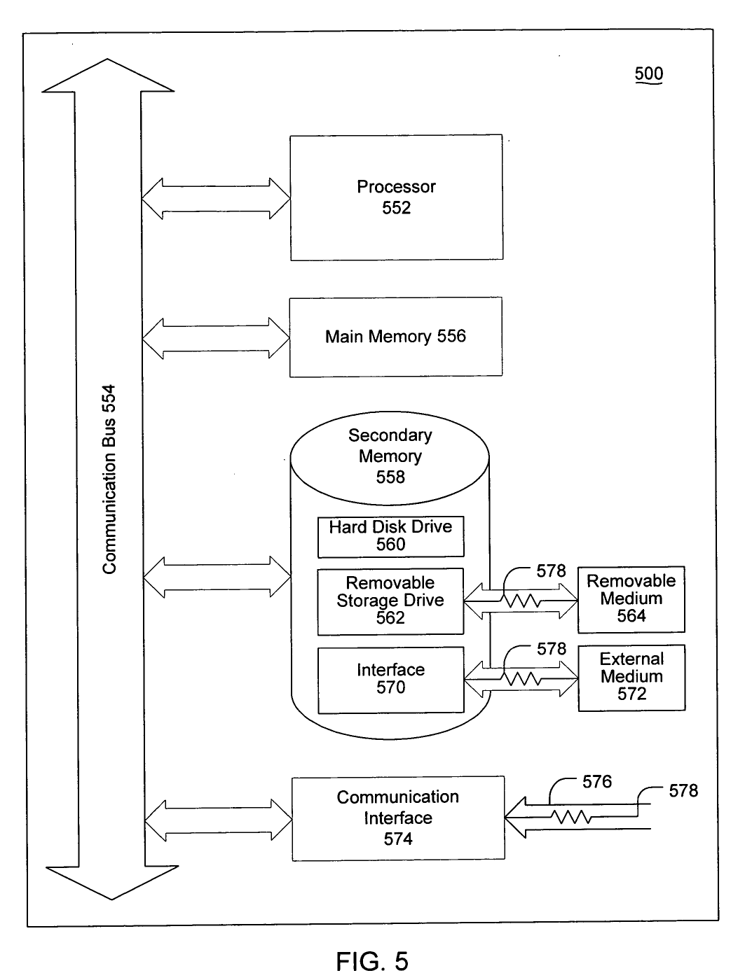

With reference to FIGS. 2 and 5, the system 10 includes a control module 20. The generic computer 500 shown and discussed in detail below with respect to FIG. 5 is an example of a control module 20 that may be used to implement the system and method of the present invention. Sensors 16 are in communication with the control module 20 for obtaining and transmitting continuous real-time measurement data for a large number of measured parameters (e.g., greater than 50 parameters may be measured and collected continuously during vehicle operation) to a central database (e.g., see memory 556 and/or memory 558, FIG. 5). A vehicle parameter tracking mechanism (e.g., J1939 CAN bus, OBD II bus, JTAG bus) 18 may automatically track the measured parameters and communicate information related to the measured parameters with the control module 20 via a communication channel 576 (FIG. 5). The control module 20 includes a module 22 to accept the data from the external data channel and file the data into parameter data logs, a module 24 to analyze data trends and associations, a module 26 to identify subsystem and component failures, a module 28 to classify and report pending failures and failures, and a module 30 to update and train the data analysis software to recognize new failures and pending failures.

An exemplary method of failure prediction of one or more components or sub-systems 9 of the heavy-duty hybrid-electric or electric vehicle 8 will be described. The method includes an exemplary process 100 for diagnosing a potential failure in a hybrid vehicle or electric vehicle, and an exemplary process 110 of automatic learning for retraining the system with new failure data.

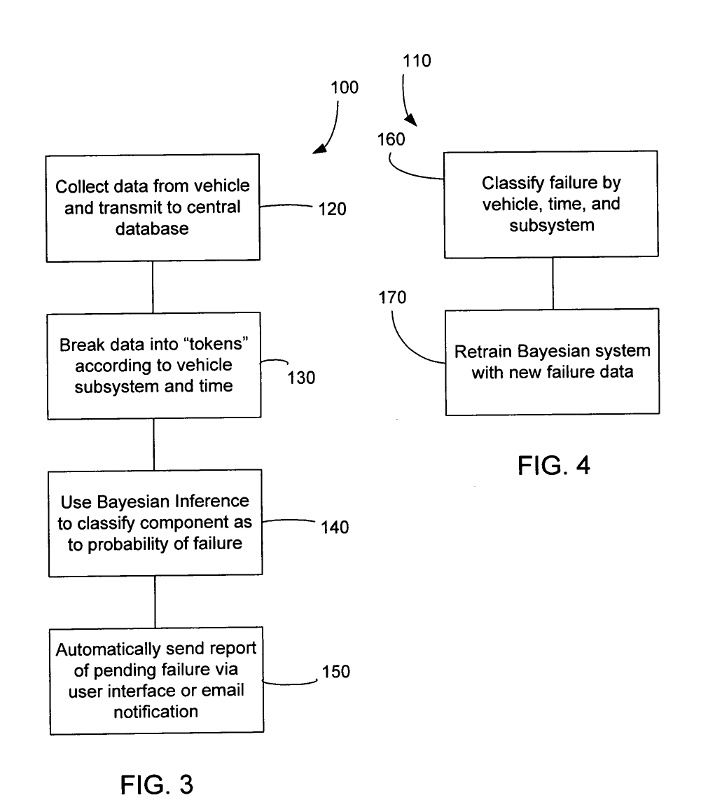

With reference to FIG. 3, the exemplary process 100 for diagnosing a potential failure in a hybrid vehicle or electric vehicle will be described. At step 120, continuous real-time measurement data for a large number of measured parameters (greater than 50 parameters may be measured and collected continuously during vehicle operation) on-board a heavy-duty hybrid-electric or electric vehicle is collected and transmitted to a central database (e.g., memory 556 and/or memory 558). At step 130, the data is broken into “tokens” according to vehicle subsystem and time. At step 140, Bayesian Inference is used to classify the relevant component(s) as to probability of failure. Other classification techniques and algorithms such as those based on regression analysis or artificial neural networks could be used in place of or in addition to Bayesian Inference. At step 150, a report is automatically sent via an email notification, user interface, or other communication means/method of the pending failure.

With reference to FIG. 4, an exemplary method 110 of automatic learning for retraining the system with new failure data will be described. It should be noted, the method 110 may be a separate process or may be part of method 100 described above. At step 160, a failure is classified by at least vehicle, time, and subsystem. At step 170, the Bayesian system is retrained with the new failure data to “learn” the new failure. For classification systems other than Bayesian, the specific classification system “learns” new failures from a retraining system corresponding to the specific classification system used.

The methods 100, 110 are loops repeated over and over by the system 10.

Thus, the system 10 and method of the present invention collects large amounts of continuous real-time measurement data for a large number of measured parameters on-board a heavy-duty hybrid-electric or electric vehicle, and uses statistical analysis and automatic learning techniques on time histories to discover and learn about single and multiple parameter interactions that can be used for status and failure prediction. Bayesian and/or other auto learning analysis processing is applied to the data collected to discover cross correlations that can be used to identify performance degradation and pending component failure. Any identified malady is assigned an error code that is communicated to maintenance personnel. Furthermore, the discovered multiple parameter relationship is communicated to all the other maintenance personnel and/or computers for that vehicle class fleet.

FIG. 5 is a block diagram illustrating an exemplary computer 500 as may be used in connection with the system 10 to carry out the above-described methods, the above-described communication functions, and other functions. However, other computers and/or architectures may be used, as will be clear to those skilled in the art.

The computer 500 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer 500. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer 500 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium or removable memory device 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer 500 as electrical communication signals 578.

In alternative embodiments, secondary memory 558 may include other similar means for allowing computer programs or other data or instructions to be loaded into the computer 500. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer 500.

Computer 500 may also include a communication interface 574. The communication interface 574 allows software and data to be transferred between computer 500 and external devices (e.g. printers), networks, or information sources. For example, computer software or executable code may be transferred to computer 500 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/internet protocol (“TCP/IP”), serial line internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of communication means including wire or cable, fiber optics, conventional phone line, cellular phone link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer 500 to perform the various functions of the present invention as previously described.

In this description, the term “computer readable medium” is used to refer to any media used to provide computer executable code (e.g., software and computer programs) to the computer 500. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer 500.

In an embodiment that is implemented using software, the software may be stored on a computer readable medium and loaded into computer 500 by way of removable storage drive 562, interface 570, or communication interface 574. In such an embodiment, the software is loaded into the computer 500 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

The above description of the disclosed embodiments and exemplary methods is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. method of collecting and analyzing large amounts of continuous real time vehicle measurement data from more than 50 monitored parameters, comprising:
providing a system for collecting and analyzing large amounts of continuous real time vehicle measurement data from more than 50 monitored parameters;
receiving continuous real time vehicle measurement data from more than 50 monitored parameters and filing the data into parameter data logs;
analyzing data trends and associations in the vehicle measurement data;
identifying subsystem and component failures from the analyzed data trends and associations;
classifying and reporting pending failures and failures based on the identified subsystem and component failures;
updating and training the system to recognize new failures and pending failures.

2. The method of claim 1, wherein the system includes main memory and secondary memory, the secondary memory including one or more of a hard disk drive, a removable data storage drive with a removable data storage medium and an interface to an external data storage medium.

3. The method of claim 1, wherein the system includes one or more processors, the one or more processors including one or more of a coprocessor, a slave processor, a multiple processor system, an input/output processor, a floating point mathematical processor, a special purpose signal processing processor, an auxiliary discrete processor, and an auxiliary integrated processor.

4. The method of claim 1, wherein the system includes a statistical data analysis module to analyze data trends and associations in the vehicle measurement data.

5. The method of claim 1, wherein the system includes a data failure and pending failure identification and classification module using one or more of Bayesian Inference, Regression Analysis, and Artificial Neural Networks.

6. The method of claim 5, wherein the system includes a module to receive continuous real time vehicle measurement data from more than 50 monitored parameters and file the data into parameter data logs; a module to analyze data trends and associations in the vehicle measurement data; a module to identify subsystem and component failures from the analyzed data trends and associations; a module to classify and report pending failures and failures based on the identified subsystem and component failures; a module to update and train the system to recognize new failures and pending failures, and the update and train module is matched to the identification module and the classification module.

7. A computer-implemented system for collecting and analyzing large amounts of continuous real time vehicle measurement data from more than 50 monitored parameters, comprising:
a module to receive continuous real time vehicle measurement data from more than 50 monitored parameters and file the data into parameter data logs;
a module to analyze data trends and associations in the vehicle measurement data;
a module to identify subsystem and component failures from the analyzed data trends and associations;
a module to classify and report pending failures and failures based on the identified subsystem and component failures;
a module to update and train the system to recognize new failures and pending failures.

8. The system of claim 7, wherein the system includes main memory and secondary memory, the secondary memory including one or more of a hard disk drive, a removable data storage drive with a removable data storage medium and an interface to an external data storage medium.

9. The system of claim 7, wherein the system includes one or more processors, the one or more processors including one or more of a coprocessor, a slave processor, a multiple processor system, an input/output processor, a floating point mathematical processor, a special purpose signal processing processor, an auxiliary discrete processor, and an auxiliary integrated processor.

10. The system of claim 7, wherein the system includes a statistical data analysis module to analyze data trends and associations in the vehicle measurement data.

11. The system of claim 7, wherein the system includes a data failure and pending failure identification and classification module using one or more of Bayesian Inference, Regression Analysis, and Artificial Neural Networks.

12. The system of claim 7, wherein the update and train module is matched to the identification module and the classification module.
